(19) United States
(12) Patent Application Publication
(10) Pub. No.: US 2004/0083300 A1
(43) Pub. Date: Apr. 29, 2004

(54) Data communication system, terminal device, method and program therefor

(75) Inventor: Yasushi Toda, Tokyo (JP)

Correspondence Address: SCULLY SCOTT MURPHY & PRESSER, PC, 400 GARDEN CITY PLAZA, GARDEN CITY, NY, 11530

(73) Assignee: NEC Corporation, Tokyo (JP)

(21) Appl. No.: 10/689,362

(22) Filed: Oct. 20, 2003

(30) Foreign Application Priority Data
Oct. 21, 2002 (JP) 305899/2002

(51) Int. Cl. G06F 15/16

(52) U.S. Cl. 709/230

(57) ABSTRACT

In a communication system including a data terminal having a communication function adopting a code division multiplex access (CDMA) system, a coding and a decoding means in the data terminal store parameters necessary for a coding and a decoding process in the means, respectively, are stored in the process parameter buffer according to the utilization frequency data of a designated transport format, and for the utilization frequency parameters the pertinent stored parameter data are read out and utilized without performing recalculation, thus reducing power consumption necessary for calculation.

### BACKGROUND OF THE INVENTION

This application claims benefit of Japanese Patent Application No. 2002-305899 filed on Oct. 21, 2002, the contents of which are incorporated by the reference.

The present invention relates to data communication systems, data communication terminal devices and data communication methods based on portable data communication terminals or the like as well programs for the same.

FIG. 3 shows an arrangement example of a coding means and a decoding means in a prior art portable data terminal.

A spread spectrum transfer system is used as digital signal transmission system in connection with CDMA (Code Division Multiple Access). In the spread spectrum transfer system, a plurality of spread codes or so-called PN spread signals are used for communication channel formation. These spread codes are the same as those used in a spread process carried out on the transmitting side, and are used in an inverse spread process on received wave. Thus, it is possible to take out desired data from the received wave which contains interference waves.

In a data terminal having a communication function based on the above system, a coding and a decoding means 2A and 4A require different process parameters depending on the sizes of transmitted and received data. Accordingly, in the coding means 2A a coding parameter process unit 26 calculates a coding process parameter S110 and a transmitting process parameter S107 on the basis of a transmission parameter S101 preset by an upper rank controller 1 by using a transport format of transmitted data S102, and a coding process unit 27 processes the transmitted data S102 by using the coding process data S110 to form coded/multiplexed data and sends out the same data to a transmitting Means 3. In the decoding means 4A, on the other hand, a decoding process unit 47 obtains TFCI (Transport Format Combination Indicator) data S212 from prior-to-decoding data S209 received in a receiving means 5, and a decoding parameter process unit 46 calculates a decoding process parameter S211 and a receiving process parameter S208 by using the data S212 and a reception parameter S201 preset by the upper rank controller 1. A decoding process unit 4A obtains decoded received data S202 from the prior-to-decoding data S209 by using decoding process parameter S211, and feeds the obtained data to the upper controller 1.

The coding and decoding means 2A and 4A sets the process parameters S110 and S211 in coding and decoding process units 27 and 47 respectively for processes therein, thus effecting the coding of the transmitted data and the decoding of the received data, respectively.

The transmitted and received data are roughly classified into those of discrete control channel (DCCH) and those of discrete traffic channel (DTCH), and data presence/absence check and data size updating are made independently for these channels. This means that the transport format combination indicator (TFCI) updating is done frequently even with constant data transmission/reception data rate. The frequent updating dictates frequent re-calculation of the process parameters S110 and S221 in the coding and decoding parameter process units 26 and 46. In this case, the same calculation parameters are calculated, giving rise to wasteful calculation process, which is undesired in view of the consumed power required for the calculation.

It is conceivable to store all of the process parameters S110 and S211 and the transmission and receiving process parameters S107 and S207 in a non-volatile memory in the portable data terminal. However, transport format combinations of services are large in number, and calculation parameters to be reserved are enormous and requires a large scale memory. Also, in the case when a physical channel parameter is updated in data transmission or reception, the coding process parameter S110 has to be re-calculated. Since it is not seldom that physical channel parameters are updated in the network, it is not seldom that re-calculation becomes necessary. Therefore, in the method in which necessary transmission and reception parameters are all stored in a non-volatile memory, the portable data terminal of this type has problems in connection with consumed power, size reduction and cost.

A channel coding and decoding system also has been proposed, which permits reducing power consumed in the above parameter calculation processes. This system is arranged such that when the transport format combination indicator (TFCI) in the present transport time interval (TTI) is the same as the transport format combination indicator (TFCI) in the immediately preceding time interval (TTI), the consumed power required for the parameter calculation process of channel decoding and rate de-matching with respect to received data and also for the parameter calculation process channel coding and rate matching with respect to transmitted data, is reduced by stopping these parameter calculation processes and using parameter values obtained in the preceding calculation (see Literature 1: Japanese Patent Laid-open No. 2002-247127, for instance).

This prior art proposal, however, is predicated on a mere notice as to whether the transport format combination indicators (TFCI) in the present and immediately preceding transport time intervals (TTI) are the same. This means, for instance, that in a situation that the same state occurs in two or three successive transport time intervals (TTI), the parameter calculation processes become necessary for every interval (TTI). Therefore, it is difficult to reduce consumed power required for the calculation processes by reducing the number of times the parameter calculation processes become necessary.

### SUMMARY OF THE INVENTION

An object of the present invention is to provide a data communication system, a data communication terminal device and a data communication method, which are predicated in a notice of the frequency of utilizing parameters necessary for the coding and decoding processes, and further a program for the same for further reduction of consumed power necessary for the processes.

To solve the above problems, the data communication system, data communication terminal device and data communication method and program for the same according to the present invention have the following featured structures.

According to a first aspect of the present invention, there is provided a data communication system constructed as a transmitting side data communication terminal device comprising a coding means for generating, by receiving supplied transmitted data and transmission parameter, coded/multiplexed transmitted data corresponding to the transmitted data and transmission parameter and a transmitting process parameter used for a transmitting process on the coded/multiplexed transmitted data, wherein; the coding means includes: the transmitting side data communication terminal device having a coding process unit for obtaining the coded/multiplexed transmitted data corresponding to the transmitted data by using a supplied coding process parameter, a parameter calculation check unit for checking, according to transport format data contained in the transmission parameter, whether the process parameter concerning a pertinent transport format combination has been calculated, a coding parameter calculation unit for calculating the process parameter including the coding process parameter and the transmitting process parameter according to the transmission parameter, and a buffer control means for reading out and storing a pertinent process parameter with respect to the process parameter buffer according to a buffer control signal form the parameter calculation check unit, while updating utilization frequency data; and a receiving side data communication terminal unit including a decoding means for receiving non-decoded data supplied from a receiving means, which executed process on the received data by using a receiving process parameter, and generating decoded received data by using a supplied reception parameter, the decoding means having a decoding process unit for obtaining decoded received data by decoding non-decoded data supplied from the receiving means, which executes a process using the receiving process parameter, a parameter calculation check unit for checking, at the time of the reception and by using transport format combination indicator (TFCI) data obtained from the decoding process unit, whether the process parameters in the pertinent transport format combination have been calculated, a decoding parameter calculation unit for calculating the process parameter including the decoding process parameter and the receiving process parameter, a process parameter buffer for preserving a plurality of process parameters, and a buffer control means for reading out and storing a pertinent process parameter with respect to the process parameter buffer according to a buffer control signal from the parameter calculation check unit, while updating the utilization frequency data.

According to a second aspect of the present invention, there is provided a data communication terminal comprising a coding means for generating, by receiving supplied transmitted data and transmission parameter, coded/multiplexed transmitted data corresponding to the transmitted data and transmission parameter and a transmitting process parameter used for a transmitting process on the coded/multiplexed transmitted data, wherein; the coding means includes: the transmitting side data communication terminal device having a coding process unit for obtaining the coded/multiplexed transmitted data corresponding to the transmitted data by using a supplied coding process parameter, a parameter calculation check unit for checking, according to transport format data contained in the transmission parameter, whether the process parameter concerning a pertinent transport format combination has been calculated, a coding parameter calculation unit for calculating the process parameter including the coding process parameter and the transmitting process parameter according to the transmission parameter, and a buffer control means for reading out and storing a pertinent process parameter with respect to the process parameter buffer according to a buffer control signal form the parameter calculation check unit, while updating utilization frequency data.

According to a third aspect of the present invention, there is provided a data terminal device comprising a decoding means for receiving non-decoded data supplied from a receiving means, which executed process on the received data by using a receiving process parameter, and generating decoded received data by using a supplied reception parameter, wherein the decoding means includes a decoding process unit for obtaining decoded received data by decoding non-decoded data supplied from the receiving means, which executes a process using the receiving process parameter, parameter calculation check unit for checking, at the time of the reception and by using transport format combination indicator (TFCI) data obtained from the decoding process unit, whether the process parameters in the pertinent transport format combination have been calculated, a decoding parameter calculation unit for calculating the process parameter including the decoding process parameter and the receiving process parameter, a process parameter buffer for preserving a plurality of process parameters, and a buffer control means for reading out and storing a pertinent process parameter with respect to the process parameter buffer according to a buffer control signal from the parameter calculation check unit, while updating the utilization frequency data.

The process parameter buffer stores preference rank record flag, use history of a plurality of a plurality of times of past use of transport format combination indicator (TFCI) and one or more items of the number of times of use of each TFCI together with the pertinent process parameter.

The process parameter buffer stores preference rank record flag, use history of a plurality of a plurality of times of past use of transport format combination indicator (TFCI) and one or more items of the number of times of use of each TFCI together with the pertinent process parameter.

The parameter calculation check unit causes, when it decides that the pertinent process parameter has not net been calculated, the coding parameter process unit to calculate the process parameter and issues, when the process parameter has been calculated, an instruction to the buffer control means for reading out the process parameter from the process parameter buffer and using the read-out process parameter.

The parameter calculation check unit causes, when it decides that the pertinent process parameter has not net been calculated, the coding parameter process unit to calculate the process parameter and issues, when the process parameter has been calculated, an instruction to the buffer control means for reading out the process parameter from the process parameter buffer and using the read-out process parameter.

The buffer control means adds, to the contents in the process parameter buffer, the number of times of use of transport format combination indicator (TFCI) in a pertinent parameter table, with respect to which reading and storing are done, while updating TFCI use history.

In the reading and storing of the process parameter with respect to the process parameter buffer, the buffer control means uses the area of a non-use parameter table if such non-use parameter table is present.

The buffer control means is constructed such that when no non-use parameter table is present in the process parameter buffer at the time of storing the process parameter buffer, the buffer control means determines a parameter table to be a superscription subject according to the result of a weighing process on at least either the use history of a plurality of times of past use of transport format combination indicator (TFCI).

When no data transport rate restriction can be externally imposed, an upper rank system controls the setting of a pertinent preference rank record flag in the process buffer parameter according to the presence/absence data about discrete control channel (DCCH) and a transport format combination indicator (TFCI) as a combination of the maximum and minimum data quantity discrete traffic channels (DTCH).

No data transport rate restriction can be externally imposed, an upper rank system controls the setting of a pertinent preference rank record flag in the process parameter buffer according to the presence/absence data about discrete control channel (DCCH) and a transport format combination indicator (TFCI) as a combination of the maximum and minimum data quantity ones of the discrete traffic channel (DTCH) transport formats within the transport rate restriction.

Process buffer parameter is capable of setting the management of the supply and stop of its own operation power and operation clock for each parameter table and also capable of stopping the supply of the operation power and/or operation clock to the non-use parameter tables.

The coding parameter calculation unit is constituted by hardware such as electronic circuits, and the supply of its own operation power and/or operation clock is stopped when the process parameters of all transport format combination indicators (TFCI) in the utilized service have been calculated and stored in the process parameter buffer.

The coding parameter calculation unit is constituted by hardware such as electronic circuits, and the supply of its own operation power and/or operation clock is stopped when the process parameters of all transport format combination indicators (TFCI) in the utilized service have been calculated and stored in the process parameter buffer.

The coding parameter calculation unit is constituted by hardware such as electronic circuits, and when the number of transport format combination indicators (TFCI) in the utilized service is less than the number of the parameter tables in the process parameter buffer, it calculates the process parameters with respect to all the TFCIs by making use of an idle time in the process.

The coding parameter calculation unit is constituted by hardware such as electronic circuits, and when the number of transport format combination indicators (TFCI) in the utilized service is less than the number of the parameter tables in the process parameter buffer, it calculates the process parameters with respect to all the TFCIs by making use of an idle time in the process.

The process parameter buffer can read out a part of full data possessed by itself at a desired timing into the upper rank controller for storing the read-out data in a pertinent non-volatile memory at a desired timing.

The same service is utilized at the next time, initial data can be transported from the non-volatile memory to the process parameter buffer.

A part or full data held in the process parameter buffer are read out into the upper rank controller at a desired timing for storing the read-out data in a predetermined service in the network at a desired timing.

When utilizing the same service at the next time, initial data can be read-out from the service and transported to the process parameter buffer.

According to a fourth aspect of the present invention, there is provided a data communication method in a communication system comprising a transmitting side and a receiving side data communication terminal device each having a communication function adopting a code division multiple access (CDMA) system, wherein: a coding function part in the transmitting side data communication terminal device and a decoding function part in the receiving side data communication terminal device calculate, in calculating processes, parameters necessary for a coding and a decoding process in the coding and decoding function parts, respectively, according to designated transport format utilization frequency data and holds the calculated parameters in the own storage function parts, and for high utilization frequency parameters they read out and utilize parameters held in the storage function parts without doing re-calculation, thus reducing power consumption necessary for calculation.

According to a fifth aspect of the present invention, there is provided a data communication method by a data terminal having a communication function adopting a code division multiple access (CDMA) system, wherein: a coding function part in the data terminal calculates, in a calculating operation, a parameter necessary for its coding process and holds the calculated parameter in its own storage function part, and for high utilization frequency parameters it reads out and utilize parameter data held in the storage function part without doing re-calculation, thus reducing power consumption necessary for calculation.

According to a sixth aspect of the present invention, there is provided a data communication method by a data communication terminal device having a communication function adopting a code division multiple access (CDMA) system, wherein: a decoding function part in the data communication terminal device calculates, by a calculating process, a parameter necessary for its decoding process and holds the calculated parameter in its own storage function part, and for high utilization frequency parameters it reads out and utilize parameter data held in the storage function part without doing re-calculation, thus reducing power consumption necessary for calculation.

The updating of the parameter data held in the storage function part and the utilization frequency are managed, and the presence/absence data of discrete control channel (DCCH) data and the transport format combination indicator (TFCI) as a combination of the maximum and minimum ones of discrete traffic channel (DTCH) transport formats are preferentially stored in the storage function part, while regarding the other TFCIs the remainder of the pertinent parameters are selectively stored according to the utilization frequency thereof.

The preference rank of the parameter to be applied is updated according to the transport rate control data or the receiving sensitivity data given from the network.

At a desired timing a part or all of the process parameters and utilization frequency data stored in the storage function part are written in applied non-volatile memories, and at the next and following times of utilization the process parameters and utilization frequency data stored in the non-volatile memory are used.

According to a seventh aspect of the present invention, there is provided a program for performing a data communication method in a communication system comprising a transmitting side and a receiving side data communication terminal device each having a communication function adopting a code division multiple access (CDMA) system, wherein: a coding function part in the transmitting side data communication terminal device and a decoding function part in the receiving side data communication terminal device calculate, in calculating processes, parameters necessary for a coding and a decoding process in the coding and decoding function parts, respectively, according to designated transport format utilization frequency data and holds the calculated parameters in the own storage function parts, and for high utilization frequency parameters they read out and utilize parameters held in the storage function parts without doing re-calculation, thus reducing power consumption necessary for calculation.

According to an eighth aspect of the present invention, there is provided a program for performing a data communication method by a data terminal having a communication function adopting a code division multiple access (CDMA) system, wherein: a coding function part in the data terminal calculates, in a calculating operation, a parameter necessary for its coding process and holds the calculated parameter in its own storage function part, and for high utilization frequency parameters it reads out and utilize parameter data held in the storage function part without doing re-calculation, thus reducing power consumption necessary for calculation.

According to a ninth aspect of the present invention, there is provided a program for performing a data communication method by a data communication terminal device having a communication function adopting a code division multiple access (CDMA) system, wherein: a decoding function part in the data communication terminal device calculates, by a calculating process, a parameter necessary for its decoding process and holds the calculated parameter in its own storage function part, and for high utilization frequency parameters it reads out and utilize parameter data held in the storage function part without doing re-calculation, thus reducing power consumption necessary for calculation.

Other objects and features will be clarified from the following description with reference to attached drawings.

### BRIEF DESCRIPTION OF THE DRAWINGS

FIG. 1 is a block diagram showing an embodiment of the data communication terminal device according to the present invention;

FIG. 2 is a block diagram showing an embodiment of the data communication terminal device according to the present invention; and

FIG. 3 shows an arrangement example of a coding means and a decoding means in a prior art portable data terminal.

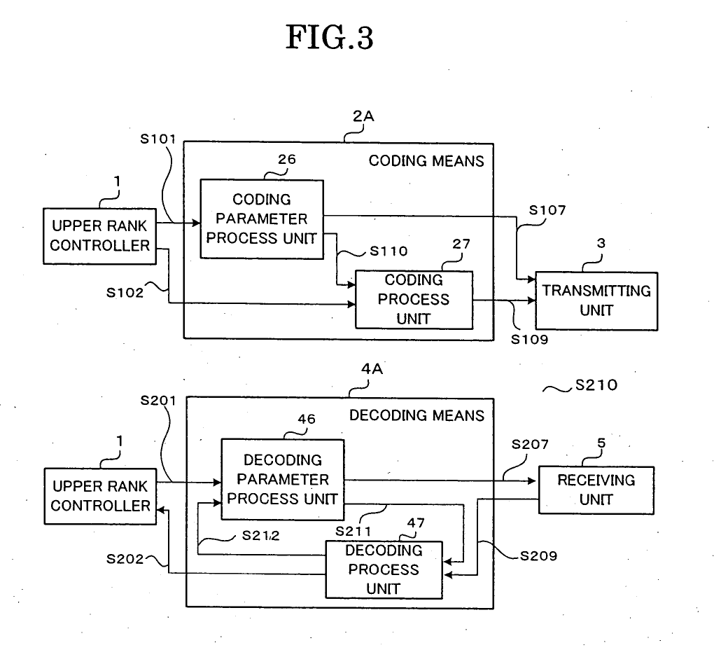

### PREFERRED EMBODIMENTS OF THE INVENTION

Preferred embodiments of the present invention will now be described with reference to the drawings.

Features of the present invention will first be summarized from the method invention standpoint. These feature methods are made to be programs, which are for carrying out these method and can be stored in the data recording medium.

According to the present invention, in a communication system including a data terminal having a communication function adopting a code division multiple access (CDMA) system, a coding and a decoding means of the data terminal store parameters necessary for coding and decoding processes in the above means in their own process parameter buffers on the basis of utility frequency data of a designated transport format, so that they can read out and utilize the data of the stored parameters without need of re-calculating high utilization frequency parameters and thus reduce power consumption necessary for the processes.

Buffer control means which manage the updating of the above process parameters and the utilization frequency data, preferentially store the presence/absence of data of discrete control channels (DCCH) and the transport format combination indicator (TFCI) as a combination of the maximum and minimum data quantity transport formats of the discrete traffic channels (DTCH) in the process parameter buffers, while selectively storing, regarding the other TFCI, the remainders of the process parameter buffers according to the utilization frequency.

The buffer control means can update the priority order of the process parameter buffers according to transport rate limiting data or receiving sensitivity data provided from the network.

Furthermore, at any time the process parameters stored in the process parameter buffers and the utilization frequency data can be partly or fully written in a non-volatile memory, and at the next and following times of utilization, the process parameters and utilization frequency data stored in the non-volatile memory can be utilized.

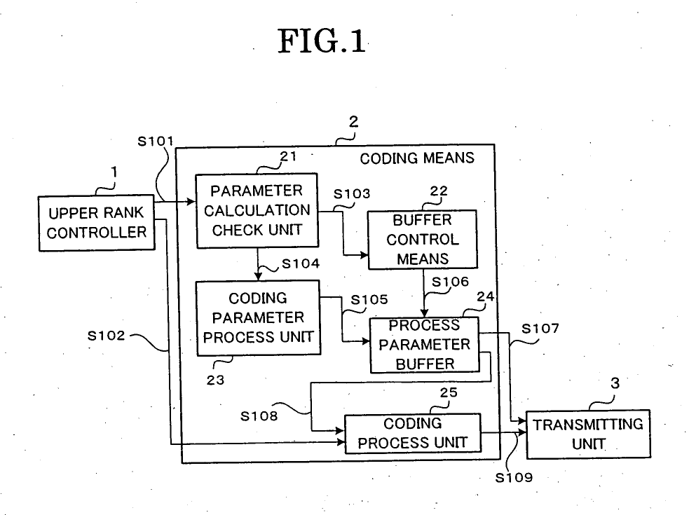

FIG. 1 is a block diagram showing an embodiment of the data communication terminal device according to the present invention. The illustrated data communication terminal device is a portable data terminal (i.e., transmitting side data communication terminal device) having a communication function based on the code division multiple access (CDMA) system, and has a coding means 2. The coding means 2 receives transmitted data S102 and a transmission parameter S101, and generates coded/multiplexed transmitted data S109 corresponding to the transmitted data S102 and the transmission parameter S101 and a transmitting process parameter S107 used for a transmitting process on the coded/multiplexed transmitted data S109, the generated data and parameter being fed to a pertinent transmitting means 3.

The coding means 2 includes a coding process unit 25 for obtaining the coded/multiplexed transmitted data S109 corresponding to the transmitted data S102 by using a supplied coding process data S108, a parameter calculation check unit 21 for performing a check, according to transport format data contained in the transmission parameter S101 preset by an upper rank controller 1 at the time of transmission, as to whether a process parameter concerning a pertinent transport format combination has already been calculated, a coding parameter process unit 23 for calculating, in response to the reception of a calculation start command S104 based on the decision by the parameter calculation check unit 21 that the process parameter has not yet been and has to be calculated, a process parameter S105 including the coding process parameter and the transmission process parameter S107 according to the transmission process parameter S107, a process parameter buffer 24 for storing the above plurality for process parameters, and a buffer control means 22 for generating a parameter table control signal S106 according to a buffer control signal 103 from the parameter calculation check unit 21 and reading out and storing pertinent process parameter with respect to the process parameter buffer 24 while updating the utilization frequency data.

The process parameter buffer 24 has areas, in which the process parameter S105 including the process parameters calculated in the coding parameter process unit 23, i.e., the coding process parameter S108 necessary in the coding process unit 25 and the transmitting process parameter S107 necessary in the transmitting unit 3, TFCI used, table use flag, parameter calculation end flag, preference rank storage flag, a plurality of tables constituted by part of or full number of table use times, and history of a plurality of times of use of past transport format combination indicators (TFCI) are stored, and is capable of being updated by the buffer control means 22.

The coding process unit 25 performs coding and multiplexing according to the preset coding process parameter S108 and transmitted data S102, and sets the coded/multiplexed data S109 in the transmitting means 3.

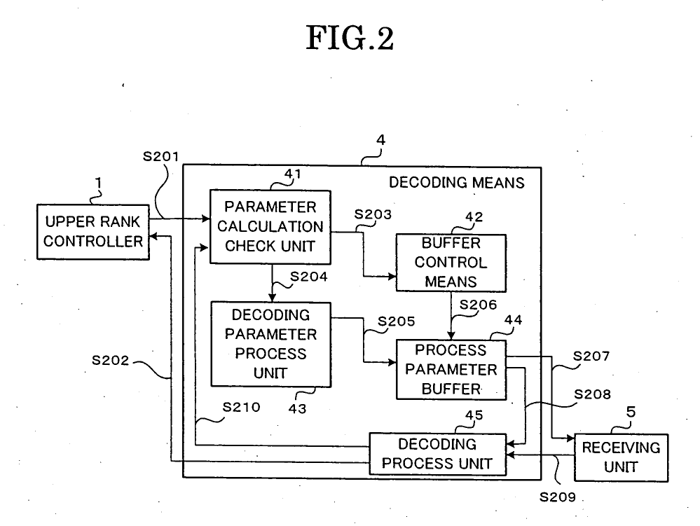

FIG. 2 is a block diagram showing an embodiment of the data communication terminal device according to the present invention. The illustrated data communication terminal unit is a portable data terminal (i.e., receiving side data communication terminal device) having a communication function based of the code division multiplex access (CDMA) system, and has a decoding means 4. The decoding means 4 receives non-decoded data S209 from a receiving means 5, which executes process on received data by using a receiving process parameter S207, and generates decoded received data S202 by using a reception parameter S201 from an upper rank controller 1.

The decoding means 4 includes a decoding process unit 45 for decoding the non-decoded data S209 fed from the receiving means 5, which executes a process using a receiving process parameter S207, and thus obtaining decoded received data S202, a parameter calculation check unit 41 for executing a check at the time of reception, by using transport format combination indicator (TFCI) data obtained from the decoding process unit 45, as to whether a process parameter S205 in a pertinent transport format combination has been calculated, a parameter process unit 43 for calculating, in response to the reception of a calculation start command S204 based on the decision by the parameter calculation check unit 41 that the process parameter has not yet been and has to be calculated, the process parameter S205 including a decoding process parameter S208 and a receiving process parameter S207, a process parameter buffer 44 for preserving a plurality of process parameters S205, and a buffer control means 42 for reading and storing a process parameter by using a parameter table control signal S206 to the process parameter buffer 44 according to a buffer control signal from the parameter calculation check unit 41, while also updating the utilization frequency data.

The process parameter buffer 44 has areas, in which the process parameter S205 including process parameters calculated in the decoding parameter process unit 43, i.e., a decoding process parameter S208 necessary in the decoding process unit 45 and a receiving process parameter S207 necessary in the receiving means 5, used TFCI, table use flag, parameter calculation end flag, preference rank record flag, a plurality of parameter tables constituted by a part of or full number of table use times and the history of a plurality of numbers of past TFCI use are stored, and is capable of being updated by the buffer control means 42.

The decoding process unit 45 decodes prior-to-decoding data S209 fed from the receiving means 5 by using the preset decoding process parameter S208, and transfers the received data S202 to the upper rank controller 1.

The operation of the coding means in the embodiment of the portable data terminal (i.e., receiving side data communication terminal device) according to the present invention will now be described in detail with reference to FIG. 1.

At the start of a transmission channel, the upper rank controller 1 which is realized by a control program of a CPU or the like, sets the channel parameter S101 corresponding to a pertinent service in the coding process unit 25 in the coding unit 2, and also performs initial setting of the process parameter S105 in the process parameter buffer 24.

The upper rank controller 1 executes the initial setting of the process parameter S105 in the following procedure.

In the case of absence of any restriction imposed on the rate of transport from the network, when the presence/absence of data of discrete (respective) control channels (DCCH) and the process parameters of a transport format combination indicator (TFCI), which is constituted by a maximum and a minimum data quantity one of the discrete traffic channel (DTCH) transport formats (DTCH), has been stored in the non-volatile memory, the upper rank unit 1 sets the pertinent TFCI, process parameter thereof, preference rank record flag and a part of or full number of times of table use in the process parameter buffer 24 in the coding means 2, and when the process parameter S105 has been set, a parameter non-calculation flag is cleared (i.e., set to “calculation end”). When no process parameter has been stored in the non-volatile memory, the upper rank unit 1 sets the TFCI in a parameter table in the process parameter buffer 24 and also sets the parameter non-calculation flag. When no number of times of table use has been stored in the non-volatile memory, the upper rank unit 1 sets an initial value as the number of times of table use.

In the case of presence of transport rate restriction data given from the network, when the presence/absence of data of discrete (respective) control channels (DCCH) and the process parameters of a transport format combination indicator (TFCI), which is constituted by a maximum and a minimum data quantity within the transfer rate restriction one of the discrete traffic channel (DTCH) transport formats (DTCH), has been stored in the non-volatile memory, the upper rank unit 1 sets the pertinent TFCI, process parameter thereof, preference rank record flag and a part of or full number of times of table use in the process parameter buffer 24 in the coding means 2, and when the process parameter S105 has been set, a parameter non-calculation flag is cleared (i.e., set to “calculation end”).

When no process parameter has been stored in the non-volatile memory, the upper rank unit 1 sets the TFCI in a parameter table in the process parameter buffer 24 and also sets the parameter non-calculation flag and the preference rank record flag. When no number of times of table use has been stored in the non-volatile memory, the upper rank unit 1 sets an initial value as the number of times of table use.

However, in the case of absence of DCCH data of the above TFCI and also absence of transmission data in the minimum DTCH data quantity TFCI, in which case no coding process is necessary, the upper rank unit 1 does not set any initial value concerning the TFCI.

When a vacant area is present in a parameter table in the process parameter buffer 24 after completion of the initial value setting in the parameter table in the process parameter buffer 24, a table non-use flag is set in that vacant parameter table.

The parameter table of the process parameter buffer 24, in which the preference rank record flag has been set, can be updated only by the upper rank controller 1 and cannot be updated in the coding means 2. The parameter tables, in which no preference rank record flag has been set, can be updated by the buffer control means 22 in the coding means 2.

After completion of the setting in the individual parameter tables, the TFCI use history in the process parameter buffer 24 is cleared.

Now, the operation of the coding means 2 in case when the reception data and the transport format have been set, will be described.

When the parameter calculation check unit 21 receives preset transport format data (i.e., transmission parameter) S101, it performs a check, by using the buffer control means 22 and also with reference to TFCI data and parameter calculation flag stored in the parameter tables in the process parameter buffer 24, as to whether the process parameter S105 of the pertinent TFCI has been calculated.

When the process parameter S105 has not been calculated, the parameter calculation check unit 21 issues a process start command S104 representing the decision that the process parameter has not been and has to be calculated. Receiving this command, the coding parameter process unit 23 calculates the process parameter S105 including the coding process parameter S108 and the transmitting process parameter S107, and sets the calculated process parameter S105 in the coding process unit 25 and the transmitting means 3, while the buffer control means 22 updates the parameter tables in the process parameter buffer 24 according to an algorithm to be described later.

When the process parameter S105 of the pertinent TFCI has been calculated, the buffer control means 22 sets the process parameter S105, which has been stored in the parameter table of the pertinent TFCI in the process parameter buffer 24, to the coding process unit 25 and transmission means 3 and updates the parameter table according to the algorithm to be described later.

The buffer control means 22 operates with the following algorithm.

In the case that the coding parameter process unit 23 has calculated the process parameter S105, the buffer control means 22 sets the calculated process parameter S105 in the coding calculation unit 25 and the transmission means 3; and

(1) when the TFCI of the calculated process parameter S105 corresponds to the parameter table in the process parameter buffer 24, in which the preference rank record flag has been set, the buffer control means 22 clears the parameter non-calculation flag in the pertinent parameter table in the process parameter buffer 24 and stores the process parameter S105 in the parameter table, while updating the TFCI use history and adding the number of times of use for the parameter table;

(2) in the case of failure of correspondence of the TFCI of the calculated process parameter S105 to the parameter table of the process parameter buffer 24, in which the preference rank record flag has been set and also the presence of the table non-use parameter table found by retrieving each parameter table in he process parameter buffer 24, the buffer control means 22 clears the non-use flag and the parameter non-calculation flag in the pertinent tables and stores the process parameter S105 of the pertinent TFCI in the pertinent parameter tables, while updating the TFCI use history and setting the number of times of use of the pertinent parameter table to “1”; and

(3) in the case of failure of correspondence of the TFCI of the calculated process parameter S105 to the parameter table of the process parameter buffer 24, in which the preference rank record flag has been set, and also the absence of the non-use parameter table found by retrieving the table non-use flag in each parameter table in the process parameter buffer 24, regarding the TFCI stored in the parameter tables in the process parameter buffer 24, in which no preference rank record flag has been set, the buffer control means 22 selects, according to a function of f (n, m) obtained as a result of weighing either one or both of the numbers n and m of times of use of the TFCI obtained from the TFCI use history and the pertinent parameter, respectively, a parameter table, in which a parameter concerning the minimum utilization frequency TFCI has been stored and stores the TFCI in the selected parameter table and the process parameter S105, while updating the TFCI use history and the number of times of use of the pertinent parameter table.

When the process parameter S105 is not calculated by the coding parameter process unit 23, the buffer control unit 22 reads out the process parameter S105 from the parameter table corresponding to the pertinent TFCI in the process parameter buffer 24 and sets the read-out process parameter in the coding process unit 25 and in the transmitting means 3, while updating the TFCI use history and adds the number of times of use of the pertinent parameter table.

When the upper rank controller 1 receives a transport rate restriction during the operation of the coding means 2, it sets updating data in the process parameter buffer 24 in the coding means 2 in the following procedure.

When the presence/absence data about DCCH data subsequent to the transport rate restriction and TFCI as a combination of the maximum and minimum data quantity ones of DTCH transport formats within the transport rate restriction are present in the parameter tables in the process parameter buffer 24 after the clearing of all the preference rank record flags in the parameter tables in the process parameter buffer 24 in the coding means 2, the upper rank controller 1 sets the preference rank record flag in the pertinent parameter table.

When the pertinent TFCI is present in one of the parameter tables on process parameter buffer 24, like the initial setting process, in the presence of the process parameter S105 concerning the pertinent TFCI stored in the non-volatile memory, the upper rank controller 1 sets the TFCI, process parameter S105 thereof, preference rank record flag and a part of or full number of times of table use in the process parameter buffer 24 in the coding means 2. When the process parameter S105 has been set, the upper rank controller 1 clears (i.e., sets to “calculation completion”) the parameter non-calculation flag. When the process parameter S105 has not been stored in the non-volatile memory, the upper rank controller 1 sets the pertinent TFCI in the parameter table in the process parameter buffer 24 and also sets the parameter non-calculation flag.

When the number of times of table use has not been stored in the non-volatile memory, the upper rank controller 1 sets the number of times of table use to the initial value. At this time, the upper rank controller 1 does sequential setting from parameter tables, in which preference rank record flags have been set prior to the updating.

When re-calculation of the process parameter S105 in the process parameter buffer 24 becomes necessary after physical channel parameter updating, the upper rank controller 1 does parameter non-calculating flag setting in all the parameter tables in the process parameter buffer 24.

In the case of occurrence of a digit overshoot of the number of times of table use contained in each parameter table in the process parameter buffer 24 as a result of the addition of this number, the upper rank controller 1 subtracts a constant number from the number of times of table use in each parameter table. When the result of calculation is negative, the upper rank controller 1, does a process of setting zero or a process of dividing the number of times of table use in each parameter table by 2ⁿ.

When a request for reading the process parameter buffer 24 is provided from the upper rank controller 1, the buffer control means 22 transports a part or all of the parameter tables in the process parameter buffer 24.

The operation of the decoding means in the embodiment of the portable data terminal (i.e., receiving side data communication terminal device) according to the present invention will now be described in detail with reference to FIG. 2.

At the start of a reception channel, the upper rank controller 1 which is realized by a control program of a CPU or the like, sets the channel parameter S201 corresponding to a pertinent service in the decoding process unit 45 in the decoding unit 4, and also performs initial setting of the process parameter S205 in the process parameter buffer 44.

The upper rank controller 1 executes the initial setting of the process parameter S205 in the following procedure.

In the case of absence of any restriction imposed on the rate of transport from the network, when the presence/absence of data of discrete (respective) control channels (DCCH) and the process parameters of a transport format combination indicator (TFCI), which is constituted by a maximum and a minimum data quantity one of the discrete traffic channel (DTCH) transport formats (DTCH), has been stored in the non-volatile memory, the upper rank unit 1 sets the pertinent TFCI, process parameter thereof, preference rank record flag and a part of or full number of times of table use in the process parameter buffer 44 in the decoding means 4, and when the process parameter S205 has been set, a parameter non-calculation flag is cleared (i.e., set to “calculation end”). When no process parameter has been stored in the non-volatile memory, the upper rank unit 1 sets the TFCI in a parameter table in the process parameter buffer 44 and also sets the parameter non-calculation flag. When no number of times of table use has been stored in the non-volatile memory, the upper rank unit 1 sets an initial value as the number of times of table use.

In the case of presence of transport rate restriction data given from the network, when the presence/absence of data of discrete (respective) control channels (DCCH) and the process parameters of a transport format combination indicator (TFCI), which is constituted by a maximum and a minimum data quantity within the transfer rate restriction one of the discrete traffic channel (DTCH) transport formats (DTCH), has been stored in the non-volatile memory the upper rank unit 1 sets the pertinent TFCI, process parameter thereof, preference rank record flag and a part of or full number of times of table use in the process parameter buffer 44 in the decoding means 4 and when the process parameter S205 has been set, a parameter non-calculation flag is cleared (i.e., set to “calculation end”).

When no process parameter has been stored in the non-volatile memory, the upper rank unit 1 sets the TFCI in a parameter table in the process parameter buffer 44 and also sets the parameter non-calculation flag and the preference rank record flag. When no number of times of table use has been stored in the non-volatile memory, the upper rank unit 1 sets an initial value as the number of times of table use.

However, in the case of absence of DCCH data of the above TFCI and also absence of transmission data in the minimum DTCH data quantity TFCI, in which case no decoding process is necessary, the upper rank unit 1 does not set any initial value concerning the TFCI.

When a vacant area is present in a parameter table in the process parameter buffer 44 after completion of the initial value setting in the parameter table in the process parameter buffer 44, a table non-use flag is set in that vacant parameter table.

The parameter table of the process parameter buffer 44, in which the preference rank record flag has been set, can be updated only by the upper rank controller 1 and cannot be updated in the decoding means 4. The parameter tables, in which no preference rank record flag has been set, can be updated by the buffer control means 42 in the decoding means 4.

After completion of the setting in the individual parameter tables, the TFCI use history in the process parameter buffer 44 is cleared.

Now, the operation of the decoding means 4 in case when received data and transport format have been set will be described.

The parameter calculation check unit 41 checks, by using TFCI data S210 obtained by decoding received data S209 obtained from the receiving means 5 in the decoding process unit 45 and also the buffer control means 42 and also with reference to TFCI data and parameter calculation flags stored in the parameter tables in the process parameter buffer 44, whether the process parameter S205 of the pertinent TFCI has been calculated.

When the process parameter S205 has not been calculated, the decoding parameter process unit 43 calculates the process parameter S205 including the decoding process parameter S208 and reception parameter S207, and sets the calculated process parameter S205 in the decoding process unit 45 and the receiving means 5, and the buffer control means 42 updates the parameter tables in the process parameter buffer 44 according to an algorithm to be described hereinunder.

When the process parameter S205 of the pertinent TFCI has been calculated, the buffer control means 42 sets the process parameter S205, which has been stored in the parameter table of the pertinent TFCI in the process parameter buffer 44, to the decoding process unit 45 and receiving means 5 and updates the parameter table according to the algorithm to be described later.

The buffer control means 42 operates with the following algorithm.

In the case that the decoding parameter process unit 43 has calculated the process parameter S205, the buffer control means 42 sets the calculated process parameter S205 in the decoding calculation unit 45 and the receiving means 5; and

(1) when the TFCI of the calculated process parameter S205 corresponds to the parameter table in the process parameter buffer 44, in which the preference rank record flag has been set, the buffer control means 42 clears the parameter non-calculation flag in the pertinent parameter table in the process parameter buffer 44 and stores the process parameter S205 in the parameter table, while updating the TFCI use history and adding the number of times of use for the parameter table;

(2) in the case of failure of correspondence of the TFCI of the calculated process parameter S205 to the parameter table of the process parameter buffer 44, in which the preference rank record flag has been set, and also the presence of the table non-use parameter table found by retrieving each parameter table in he process parameter buffer 44, the buffer control means 42 clears the non-use flag and the parameter non-calculation flag in the pertinent tables and stores the process parameter S205 of the pertinent TFCI in the pertinent parameter tables, while updating the TFCI use history and setting the number of times of use of the pertinent parameter table to “1”; and

(3) in the case of failure of correspondence of the TFCI of the calculated process parameter S205 to the parameter table of the process parameter buffer 44, in which the preference rank record flag has been set, and also the absence of the non-use parameter table found by retrieving the table non-use flag in each parameter table in the process parameter buffer 44, regarding the TFCI stored in the parameter tables in the process parameter buffer 44, in which no preference rank record flag has been set, the buffer control means 42 selects, according to a function of g (n, m) obtained as a result of weighing either one or both of the numbers n and m of times of use of the TFCI obtained from the TFCI use history and the pertinent parameter, respectively, a parameter table, in which a parameter concerning the minimum utilization frequency TFCI has been stored and stores the TFCI in the selected parameter table and the process parameter S205, while updating the TFCI use history and the number of times of use of the pertinent parameter table.

When the process parameter S205 is not calculated by the decoding parameter process unit 43, the buffer control unit 42 reads out the process parameter S205 from the parameter table corresponding to the pertinent TFCI in the process parameter buffer 44 and sets the read-out process parameter in the decoding process unit 45 and in the receiving means 5, while updating the TFCI use history and adds the number of times of use of the pertinent parameter table.

When the upper rank controller 1 receives a transport rate restriction during the operation of the decoding means 4, it sets updating data in the process parameter buffer 44 in the decoding means 4 in the following procedure.

When the presence/absence data about DCCH data subsequent to the transport rate restriction and TFCI as a combination of the maximum and minimum data quantity ones of DTCH transport formats within the transport rate restriction are present in the parameter tables in the process parameter buffer 44 after the clearing of all the preference rank record flags in the parameter tables in the process parameter buffer 44 in the decoding means 2, the upper rank controller 1 sets the preference rank record flag in the pertinent parameter table.

When the pertinent TFCI is present in one of the parameter tables on process parameter buffer 44, like the initial setting process, in the presence of the process parameter S205 concerning the pertinent TFCI stored in the non-volatile memory, the upper rank controller 1 sets the TFCI, process parameter S205 thereof, preference rank record flag and a part of or full number of times of table use in the process parameter buffer 44 in the decoding means 4. When the process parameter S205 has been set, the upper rank controller 1 clears (i.e., sets to “calculation completion”) the parameter non-calculation flag. When the process parameter S205 has not been stored in the non-volatile memory, the upper rank controller 1 sets the pertinent TFCI in the parameter table in the process parameter buffer 44 and also sets the parameter non-calculation flag.

When the number of times of table use has not been stored in the non-volatile memory, the upper rank controller 1 sets the number of times of table use to the initial value. At this time, the upper rank controller 1 does sequential setting from parameter tables, in which preference rank record flags have been set prior to the updating.

When re-calculation of the process parameter S205 in the process parameter buffer 44 becomes necessary after physical channel parameter updating, the upper rank controller 1 does parameter non-calculating flag setting in all the parameter tables in the process parameter buffer 44.

In the case of occurrence of a digit overshoot of the number of times of table use contained in each parameter table in the process parameter buffer 44 as a result of the addition of this number, the upper rank controller 1 subtracts a constant number from the number of times of table use in each parameter table. When the result of calculation is negative, the upper rank controller 1, does a process of setting zero or a process of dividing the number of times of table use in each parameter table by 2ⁿ.

When a request for reading the process parameter buffer 44 is provided from the upper rank controller 1, the buffer control means 42 transports a part or all of the parameter tables in the process parameter buffer 44.

With the above embodiment of the present invention, by providing the parameter calculation check unit it is possible to store the calculated parameters in the process parameter buffer for re-use. Thus, it is possible to reduce the calculation load and hence reduce consumed power.

Also, by providing the buffer control means for updating the parameter tables in the process parameter buffer, the parameter tables can be efficiently updated from the table use history and the history of the number of times of table use. Thus, even with a low memory capacity it is possible to reduce the efforts of calculation and thus reduce consumed power.

Furthermore, when the number of TFCIs in the transmission or reception is less than the number of the parameter tables in the process parameter buffer, it is possible to reduce unnecessary power consumption by stopping power supply to memories on non-use parameter tables in the process parameter buffer.

Still further, in the case of realizing the (coding and decoding) parameter calculation units with such hardware and electronic circuits, it is possible to reduce consumed power by stopping at least either the power supply to the parameter calculation units or the clock when the number of TFCIs in the transmission or reception is less than the number of the parameter tables in the process parameter buffer or at the instant of completion of the parameter calculation for all the TFCIs.

Yet further, by reading a part or all of the calculated parameters and history data into the upper rank controller 1 at a desired timing and preserving the same in the non-volatile memory, it is possible to set a part or all of the parameters from the non-volatile memory at the next service utilization time. Thus, it is possible to improve the accuracy of the utilization history. Also, since no parameter has to be re-calculated, it is possible to reduce consumed power.

Now, a different embodiment will be described. In this embodiment, the power supply to the process parameter buffers 24 and 44 and the clock supply are managed in each parameter table as a unit, and when the number of TFCIs in the service used is less than the numbers of the parameter tables in the process parameter buffers 24 and 44 in the transmission and reception, at least either the power supply to the non-use parameter tables or the clock supply is stopped.

Also, where the coding and decoding parameter process units 23 and 43 are constituted by electronic circuits, the parameter calculation check units 21 and 41 are adapted to manage the power and clock supplies. In the case of the less number of TFCIs in the used service than the number of the parameter tables in the process parameter buffers 24 and 44 in the transmission and reception, when the process parameters for all the TFCIs have been calculated and stored in the process parameter buffers 24 and 44, at least either the power supply to the coding and decoding parameter process units 23 and 43 or the clock supply is stopped.

Furthermore, when the number of the TFCIs in the used service is less than the number of parameter tables in the process parameter buffers 24 and 44 in the transmission and reception, the process parameters S105 and S205 of all the TFCIs are calculated in advance by using an idle time in the calculation process and stored in the parameter tables in the process parameter buffers 24 and 44, and the power supply to the non-use parameter tables in the process parameter buffers 24 and 44 and the coding and decoding process units 23 and 43 and the clock supply are stopped.

A server for accumulating the used TFCI history and process parameters for each person is prepared, a part or all of the process parameter buffers 24 and 44 is preserved in the server at a desired timing, and the process parameters S105 and S205 are obtained and use when desired.

According to the present invention, it is possible, according to the frequency of use of parameters necessary for the coding and decoding processes, to reduce the frequency, at which it becomes necessary to calculate the pertinent parameters. Thus, it is possible to provide a data communication system, a data communication terminal and a data communication method, which permit further reduction power consumption necessary for the processes, and a program pertaining to the same.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is:

1. A data communication system constructed as a transmitting side data communication terminal device comprising a coding means for generating, by receiving supplied transmitted data and transmission parameter, coded/multiplexed transmitted data corresponding to the transmitted data and transmission parameter and a transmitting process parameter used for a transmitting process on the coded/multiplexed transmitted data, wherein;
the coding means includes:
the transmitting side data communication terminal device having a coding process unit for obtaining the coded/multiplexed transmitted data corresponding to the transmitted data by using a supplied coding process parameter, a parameter calculation check unit for checking, according to transport format data contained in the transmission parameter, whether the process parameter concerning a pertinent transport format combination has been calculated, a coding parameter calculation unit for calculating the process parameter including the coding process parameter and the transmitting process parameter according to the transmission parameter, and a buffer control means for reading out and storing a pertinent process parameter with respect to the process parameter buffer according to a buffer control signal form the parameter calculation check unit, while updating utilization frequency data; and
a receiving side data communication terminal unit including a decoding means for receiving non-decoded data supplied from a receiving means, which executed process on the received data by using a receiving process parameter, and generating decoded received data by using a supplied reception parameter, the decoding means having a decoding process unit for obtaining decoded received data by decoding non-decoded data supplied from the receiving means, which executes a process using the receiving process parameter, a parameter calculation check unit for checking, at the time of the reception and by using transport format combination indicator (TFCI) data obtained from the decoding process unit, whether the process parameters in the pertinent transport format combination have been calculated, a decoding parameter calculation unit for calculating the process parameter including the decoding process parameter and the receiving process parameter, a process parameter buffer for preserving a plurality of process parameters, and a buffer control means for reading out and storing a pertinent process parameter with respect to the process parameter buffer according to a buffer control signal from the parameter calculation check unit, while updating the utilization frequency data.

2. A data communication terminal comprising a coding means for generating, by receiving supplied transmitted data and transmission parameter, coded/multiplexed transmitted data corresponding to the transmitted data and transmission parameter and a transmitting process parameter used for a transmitting process on the coded/multiplexed transmitted data, wherein;
the coding means includes:
the transmitting side data communication terminal device having a coding process unit for obtaining the coded/multiplexed transmitted data corresponding to the transmitted data by using a supplied coding process parameter, a parameter calculation check unit for checking, according to transport format data contained in the transmission parameter, whether the process parameter concerning a pertinent transport format combination has been calculated, a coding parameter calculation unit for calculating the process parameter including the coding process parameter and the transmitting process parameter according to the transmission parameter, and a buffer control means for reading out and storing a pertinent process parameter with respect to the process parameter buffer according to a buffer control signal form the parameter calculation check unit, while updating utilization frequency data.

3. A data terminal device comprising a decoding means for receiving non-decoded data supplied from a receiving means, which executed process on the received data by using a receiving process parameter, and generating decoded received data by using a supplied reception parameter, wherein
the decoding means includes
a decoding process unit for obtaining decoded received data by decoding non-decoded data supplied from the receiving means, which executes a process using the receiving process parameter,
a parameter calculation check unit for checking, at the time of the reception and by using transport format combination indicator (TFCI) data obtained from the decoding process unit, whether the process parameters in the pertinent transport format combination have been calculated,
a decoding parameter calculation unit for calculating the process parameter including the decoding process parameter and the receiving process parameter, a process parameter buffer for preserving a plurality of process parameters, and
a buffer control means for reading out and storing a pertinent process parameter with respect to the process parameter buffer according to a buffer control signal from the parameter calculation check unit, while updating the utilization frequency data.

4. The data communication terminal device according to claim 2, wherein the process parameter buffer stores preference rank record flag, use history of a plurality of a plurality of times of past use of transport format combination indicator (TFCI) and one or more items of the number of times of use of each TFCI together with the pertinent process parameter.

5. The data communication terminal device according to claim 3, wherein the process parameter buffer stores preference rank record flag, use history of a plurality of a plurality of times of past use of transport format combination indicator (TFCI) and one or more items of the number of times of use of each TFCI together with the pertinent process parameter.

6. The data communication terminal device according to claim 2, wherein the parameter calculation check unit causes, when it decides that the pertinent process parameter has not net been calculated, the coding parameter process unit to calculate the process parameter and issues, when the process parameter has been calculated, an instruction to the buffer control means for reading out the process parameter from the process parameter buffer and using the read-out process parameter.

7. The data communication terminal device according to claim 3, wherein the parameter calculation check unit causes, when it decides that the pertinent process parameter has not net been calculated, the coding parameter process unit to calculate the process parameter and issues, when the process parameter has been calculated, an instruction to the buffer control means for reading out the process parameter from the process parameter buffer and using the read-out process parameter.

8. The data communication terminal unit according to one of claims 2 and 3, wherein the buffer control means adds, to the contents in the process parameter buffer, the number of times of use of transport format combination indicator (TFCI) in a pertinent parameter table, with respect to which reading and storing are done, while updating TFCI use history.

9. The data communication terminal unit according to one of claims 2 and 3, wherein in the reading and storing of the process parameter with respect to the process parameter buffer, the buffer control means uses the area of a non-use parameter table if such non-use parameter table is present.

10. The data communication terminal unit according to one of claims 2 and 3, wherein the buffer control means is constructed such that when no non-use parameter table is present in the process parameter buffer at the time of storing the process parameter buffer, the buffer control means determines a parameter table to be a superscription subject according to the result of a weighing process on at least either the use history of a plurality of times of past use of transport format combination indicator (TFCI).

11. The data communication terminal device according to one of claims 4 and 5, wherein when no data transport rate restriction can be externally imposed, an upper rank system controls the setting of a pertinent preference rank record flag in the process buffer parameter according to the presence/absence data about discrete control channel (DCCH) and a tranport format combination indicator (TFCI) as a combination of the maximum and minimum data quantity discrete traffic channels (DRCH).

12. The data communication terminal device according to one of claims 4 and 5, wherein no data transport rate restriction can be externally imposed, an upper rank system controls the setting of a pertinent preference rank record flag in the process parameter buffer according to the presence/absence data about discrete control channel (DCCH) and a transport format combination indicator (TFCI) as a combination of the maximum and minimum data quantity ones of the discrete traffic channel (DTCH) transport formats within the transport rate restriction.

13. The data communication terminal device according to one of claims 4 and 5, wherein process buffer parameter is capable of setting the management of the supply and stop of its own operation power and operation clock for each parameter table and also capable of stopping the supply of the operation power and/or operation clock to the non-use parameter tables.

14. The data communication terminal device according to claim 2, wherein the coding parameter calculation unit is constituted by hardware such as electronic circuits, and the supply of its own operation power and/or operation clock is stopped when the process parameters of all transport format combination indicators (TFCI) in the utilized service have been calculated and stored in the process parameter buffer.

15. The data communication terminal device according to claim 3, wherein the coding parameter calculation unit is constituted by hardware such as electronic circuits, and the supply of its own operation power and/or operation clock is stopped when the process parameters of all transport format combination indicators (TFCI) in the utilized service have been calculated and stored in the process parameter buffer.

16. The data communication terminal device according to claim 2, wherein the coding parameter calculation unit is constituted by hardware such as electronic circuits, and when the number of transport format combination indicators (TFCI) in the utilized service is less than the number of the parameter tables in the process parameter buffer, it calculates the process parameters with respect to all the TFCIs by making use of an idle time in the process.

17. The data communication terminal device according to claim 3, wherein the coding parameter calculation unit is constituted by hardware such as electronic circuits, and when the number of transport format combination indicators (TFCI) in the utilized service is less than the number of the parameter tables in the process parameter buffer, it calculates the process parameters with respect to all the TFCIs by making use of an idle time in the process.

18. The data communication terminal device according to one of claims 2 and 3, wherein the process parameter buffer can read out a part of full data possessed by itself at a desired timing into the upper rank controller for storing the read-out data in a pertinent non-volatile memory at a desired timing.

19. The data communication terminal device according to claim 18, wherein when the same service is utilized at the next time, initial data can be transported from the non-volatile memory to the process parameter buffer.

20. The data communication terminal device according to one of claims 2 and 3, wherein a part or full data held in the process parameter buffer are read out into the upper rank controller at a desired timing for storing the read-out data in a predetermined service in the network at a desired timing.

21. The data communication terminal device according to claim 20, wherein when utilizing the same service at the next time, initial data can be read-out from the service and transported to the process parameter buffer.

22. A data communication method in a communication system comprising a transmitting side and a receiving side data communication terminal device each having a communication function adopting a code division multiple access (DCMA) system, wherein:
a coding function part in the transmitting side data communication terminal device and a decoding function part in the receiving side data communication terminal device calculate, in calculating processes, parameters necessary for a coding and a decoding process in the coding and decoding function parts, respectively, according to designated transport format utilization frequency data and holds the calculated parameters in the own storage function parts, and for high utilization frequency parameters they read out and utilize parameters held in the storage function parts without doing re-calculation, thus reducing power consumption necessary for calculation.

23. A data communication method by a data terminal having a communication function adopting a code division multiple access (CDMA) system, wherein:
a coding function part in the data terminal calculates, in a calculating operation, a parameter necessary for its coding process and holds the calculated parameter in its own storage function part, and for high utilization frequency parameters it reads out and utilize parameter data held in the storage function part without doing re-calculation, thus reducing power consumption necessary for calculation.

24. A data communication method by a data communication terminal device having a communication function adopting a code division multiple access (CDMA) system, wherein:
a decoding function part in the data communication terminal device calculates, by a calculating process, a parameter necessary for its decoding process and holds the calculated parameter in its own storage function part, and for high utilization frequency parameters it reads out and utilize parameter data held in the storage function part without doing re-calculation, thus reducing power consumption necessary for calculation.

25. The data communication method according to one of claims 23 and 24, wherein the updating of the parameter data held in the storage function part and the utilization frequency are managed, and the presence/absence data of discrete control channel (DCCH) data and the transport format combination indicator (TFCI) as a combination of the maximum and minimum ones of discrete traffic channel (DTCH) transport formats are preferentially stored in the storage function part, while regarding the other TFCIs the remainder of the pertinent parameters are selectively stored according to the utilization frequency thereof.

26. The data communication method according to one of claims 23 to 24, wherein the preference rank of the parameter to be applied is updated according to the transport rate control data or the receiving sensitivity data given from the network.

27. The data communication method according to one of claims 23 and 24, wherein at a desired timing a part or all of the process parameters and utilization frequency data stored in the storage function part are written in applied non-volatile memories, and at the next and following times of utilization the process parameters and utilization frequency data stored in the non-volatile memory are used.

28. A program for performing a data communication method in a communication system comprising a transmitting side and a receiving side data communication terminal device each having a communication function adopting a code division multiple access (DCMA) system, wherein: a coding function part in the transmitting side data communication terminal device and a decoding function part in the receiving side data communication terminal device calculate, in calculating processes, parameters necessary for a coding and a decoding process in the coding and decoding function parts, respectively, according to designated transport format utilization frequency data and holds the calculated parameters in the own storage function parts, and for high utilization frequency parameters they read out and utilize parameters held in the storage function parts without doing re-calculation, thus reducing power consumption necessary for calculation.

29. A program for performing a data communication method by a data terminal having a communication function adopting a code division multiple access (CDMA) system, wherein: a coding function part in the data terminal calculates, in a calculating operation, a parameter necessary for its coding process and holds the calculated parameter in its own storage function part, and for high utilization frequency parameters it reads out and utilize parameter data held in the storage function part without doing re-calculation, thus reducing power consumption necessary for calculation.

30. A program for performing a data communication method by a data communication terminal device having a communication function adopting a code division multiple access (CDMA) system, wherein: a decoding function part in the data communication terminal device calculates, by a calculating process, a parameter necessary for its decoding process and holds the calculated parameter in its own storage function part, and for high utilization frequency parameters it reads out and utilize parameter data held in the storage function part without doing re-calculation, thus reducing power consumption necessary for calculation.
